(19) United States
(12) Patent Application Publication
(10) Pub. No.: US 2009/0040527 A1
(43) Pub. Date: Feb. 12, 2009

(54) Method and apparatus for speckle noise reduction in electromagnetic interference detection

(76) Inventors: Paul Dan Popescu, Winnipeg (CA); Michael G. Sowa, Winnipeg (CA); Mark D. Hewko, Winnipeg (CA)

Correspondence Address: NATIONAL RESEARCH COUNCIL OF CANADA;1200 MONTREAL ROAD, BLDG M-58, ROOM EG12, OTTAWA, ONTARIO, K1A 0R6, CA

(21) Appl. No.: 12/219,076

(22) Filed: Jul. 15, 2008

Related U.S. Application Data
(60) Provisional application No. 60/929,976, filed on Jul. 20, 2007.

(51) Int. Cl. G01B 9/02

(52) U.S. Cl. 356/491

(57) ABSTRACT

Interference measurements obtained by comparison of a same beam (i.e. same nominal polarization, intensity, coherence length and wavelength) striking a same region on a sample at a same angle, but having a different beam wavefront upon intersection with the region are shown to provide images with independent coherent speckle noise patterns. Accordingly a plurality of interference measurements with diverse beam wavefronts can be used to identify or reduce coherent speckle noise. Reduction of the coherent speckle noise can be performed by compounding the aligned images. A change in the beam wavefront may be provided by displacing the sample in the direction of the beam between or during the measurements, when the beam is a focused beam (i.e. converging or diverging).

### CROSS-REFERENCE TO RELATED APPLICATIONS

This application claims the benefit of U.S. provisional application Ser. No. 60/929,976, filed Jul. 20, 2007, the entire contents of which is herein incorporated by reference.

### FIELD OF THE INVENTION

The invention relates in general to interference detection of electromagnetic fields propagating in turbid environments, and in particular relates to coherent speckle noise reduction in interference detection.

### BACKGROUND OF THE INVENTION

The problem of coherent speckle noise arises in many contexts where interference of electromagnetic waves is used for detection, imaging or analysis. When an intense beam of electromagnetic radiation (herein light) strikes or propagates through a diffuse, scattering or turbid environment, coherent speckle noise patterns are generated. When imaging is performed, it is difficult to discern speckle noise artifacts from genuine features of studied samples that are detected, imaged or analyzed. The speckle noise artifacts do not correspond to any part of the sample found within the field of view of the instrument, but are produced by multiple scattering within the sample. The speckle noise pattern changes from image to image when an angle of the input beam, or angle of the imaging device, is varied.

For example, optical coherence tomography (OCT) is an imaging procedure that has enjoyed tremendous success since its application in medicine and biology were first demonstrated more than a decade ago [1]. The method is based on recording the demodulated pattern generated by the interference between the coherent backscattered light coming from a sample and a reference optical field. Detailed descriptions of the theoretical principles governing OCT imaging as well as the general instrumentation involved in this technique are provided in various publications [1], [2], [3], [4] and [5]. In combination with confocal microscopy, OCT has been proven to be a very efficient method for simultaneously measuring the thicknesses and refractive indices in multilayered structures [6] and [7] or coating thickness and concentricity of optical fibers [8]. Studies have also shown that, due to the sensitivity that characterizes interferometric measurements of weakly backscattering structures, OCT can produce high quality images of the eye and other transparent tissues [9] and [10].

The method was applied quite successfully to non-transparent media such as hard tissue in the oral cavity [11], arterial [12] and [13] and intestinal tissues [14]. Unfortunately, OCT images of such dense samples are plagued with a speckled appearance that arises due to optical field beam wavefront distortions caused by low-angle multiple forward scattering and diffuse multiple backscattering of coherent photons as they propagate through tissue [12] and [15].

Typically the most relevant information that is imbedded in an OCT image is provided by photons that reach the detector after a single backscattering event. As emphasized by Schmitt et al., the aforementioned type of photons provide the signal-carrying speckle in OCT images as opposed to the signal-degrading speckle that is generated by broad-angle diffuse and low-angle forward multiple-scattering events experienced by photons inside dense samples. The later speckle has the effect of reducing the correspondence between intensity variations in OCT images and local distribution of scattering centers [15] and [16]. Multiple scattering events are the root cause of this problem because they increase the probability for photons to experience a change of their travel distance relative to their ballistic path.

There are generally five approaches for reducing or eliminating speckle noise generated by photon scattering in OCT images.

A first class of techniques is based on decreasing the spatial and/or temporal coherence of the illumination sources used in the OCT interferometers (for example, [17]). Unfortunately doing so limits the range of interferometry and the resolution of the measurements due to dispersion artifacts.

A second class obtains uncorrelated optical speckle through spatial (e.g. [19], [20]) or polarization (e.g. [18], [21]), diversity. Basically comparing two interferometric images produced with differently polarized, or spatially oriented beams permits reduction of the speckle noise. The polarization varying method requires polarization controlling elements in the imaging field and mechanisms for varying them, and is not applicable for imaging samples with intrinsic birefringence properties.

U.S. Pat. No. 6,847,449 teaches a method and apparatus for reducing speckle due to multiply scattered light, without any loss of resolution, by averaging over different angles of the incident light at low input resolution, while collecting the backscattered light at a full resolution of a lens. Unfortunately the optical equipment for changing an angle of incidence may not be easy if the sample is unwieldy or imaged from a significant distance. Furthermore there may be significant differences in beam propagation with changes in angles of incidence that would discourage changes in angles. For example, a significant fraction of the beam may be reflected at the surface reducing an intensity of the beam and a quality of the interferogram, or anisotropy of the medium or high irregularity of the surface and or medium may induce changes in the imaging with different angles.

A third option is to use frequency compounding, i.e. imaging the same sample volume with two or more waves of different frequencies [22]. As the speckle pattern changes with the frequency of the beam, imaging with two or more frequencies in alternation allows for the identification of information-carrying signal components by the substantial correlation of image components on the two or more images. Unfortunately this requires a more complicated process of acquisition and post acquisition processing to perform the correlation of the images, and further requires more expensive beam sources and switching equipment. As the transmission properties of most media change with frequency, overlaying of the images acquired with different wavelengths of light may be complicated or inexact.

A fourth approach is to use of an array of detectors that are spatially distributed. This method is a variation of the angle diversity and requires more detection equipment, as well as expensive and computation-intensive correlation of images to decrease the speckle.

Finally post acquisition image cleaning techniques like phase-domain processing and zero-adjustment procedures ([23] U.S. patent application 2006/0100527 to Gregori et al.) have been known to be used to remove speckle from an image. Post acquisition processing methods are generally prone to errors resulting in reduced quality images, computation intensive, and sample-dependent (i.e. generally requires some a-priori knowledge of the morphology and composition of the sample).

In the fields of holography and projection imaging, techniques for reducing surface speckle are known. U.S. Pat. No. 6,367,935 to Wang et al. teaches a method for surface speckle reduction that involves moving a projected beam transversely in order to cancel out speckle when used for projection imaging. U.S. Pat. No. 7,119,936 also teaches moving the screen to reduce perceived speckle. Neither of these teaches motion confined to a direction of illumination. U.S. Pat. No. 6,268,941 to Halldorson teaches a method for holographic imaging that reduces speckle by moving a plate in all directions. The plate is illuminated from two angles and so it is not possible to move the plate in the direction of the illumination.

It is also known in the art to independently vary a speckle pattern by changing phase of a beam meeting a sample, for example by inserting a variable phase delay in the optical path leading to the sample, as described, for example, in [17], [18].

The problem is encountered in any region of the electromagnetic spectrum for any coherence tomography imaging method or other interference detection scheme based on interference of a reference beam with the beam coming from a sample.

There remains a need for a method and apparatus for interference detection that identifies or reduces speckle that does not require additional illumination or detection equipment and does not change an angle of incidence if the interrogation beam, and works for any sample or surrounding environment that scatters the probing electromagnetic radiation.

### SUMMARY OF THE INVENTION

Applicant has discovered in the context of OCT imaging that changing a beam wavefront of a beam as it meets the sample changes a speckle pattern produced. The application of this principle to OCT imaging is demonstrated, and the applicant submits that the principle is independent of the wavelength of the electromagnetic radiation used. A simple method for changing the beam wavefront of a focused (i.e. converging or diverging) beam is to change a position of the sample in the direction of the beam. Alternatively a transverse mode of the low-coherence source, or a diameter, a shape, an intensity distribution or a focus of the beam may be changed. The change may be continuous or discrete.

Accordingly a method for interference detection is provided. The method involves producing two sets of interference values respectively from the first and the second instances of a beam after interaction with a sample at a region of the sample, the first and second instances of the beam both taken to be representative of the sample at the region, wherein the first and second instances of the beam have a same nominal wavelength, intensity, polarization and coherence length, and meet the sample at substantially a same angle, but have different beam wavefronts upon intersection with the sample. The method then involves using differences between the two sets of interference data to identify or reduce speckle noise. Naturally a number of different beam wavefronts greater than two can be used to produce a corresponding number of sets of interference values.

The producing of the two sets of interference data may involve producing two sets of interference data for the region in sequence with a number of like regions distributed substantially uniformly over a surface of the sample, the two data sets for the regions providing an image of the sample with each pixel of the image corresponding to one region of the sample. For example, the sample may be imaged with the first instance of the beam, the beam wavefront can be changed to that of the second instance of the beam, and then imaging of the sample with the second instance of the beam may be applied. If so using the differences comprises aligning the pixels of the produced images to compare pixels of data produced from substantially overlapping regions.

Alternatively, the method may involve acquiring a first of the two sets of interference data from the first instance of the beam, and acquiring a second of the two sets of interference data at the region prior to repositioning the beam to a next region. The repositioning of the beam may involve moving the beam and stopping it at the next region, or continuously moving the beam over the sample at a slow enough speed that both instances of the beam after interaction are taken to represent the same region.

Producing the two sets of interference data may involve interfering the beam instances after interaction with the sample with a reference having a plurality of optical path length offsets to produce a plurality of interference values for each region, each interference value corresponding to an intensity of light backreflected from a respective depth of the sample, wherein using the difference between the first and second interference data involves comparing the interference values of corresponding depths of corresponding pixels of the first and second interference value sets. For example, the producing may involve superposing the beam instance after interaction on an optical path length varying reference beam that changes optical path length cyclically within a depth scan period, and sampling an interference signal produced by the superposition at a rate n times higher than the depth scan period to produce n interference values.

Accordingly an interference detection method is provided, the method involving illuminating a spot on a sample within a region of the sample with a beam of light having an axis, the beam having a first wavefront where it intersects the sample, and having a constant nominal wavelength, intensity, polarization and coherence length. The method involves producing first interference data of the sample from light collected after interaction with the sample which is taken to be representative of the region. The steps of illuminating and producing are repeated with a second spot on the sample within the region with the beam along the axis, the beam having a second beam wavefront where it intersects the sample to produce second interference data from light collected after interaction of the second spot with the sample, the light collected from the second spot is also taken to be representative of the region. Any differences between the first and second interference data is then used to identify or reduce speckle noise.

The producing may involve acquiring images of the sample at successive regions of the sample to provide corresponding pixels. The producing may involve collecting A-scans of the region. The scanning of the beam across the sample may involve continuous motion of the beam or intermittent motion. The wavefront may changed gradually or may be switched, and may be provided between image taking or concurrently therewith.

If the beam is a focused beam of light, illuminating the second spot on the sample may involve changing the wavefront by displacing the sample on the axis of the beam to change a radius of the wavefront.

An interference detection system is also provided. The detection system including: an optical path between a light source and a sample, for directing an interrogation beam onto a region of the sample along an axis; a mechanical actuator for changing a wavefront of the interrogation beam; and two beams of light collected from the region of the sample after interaction with the sample from instances of the interrogation beam having two different wavefronts at intersection with the sample, but having a substantially same angle for interference with respective reference beams.

A kit is also provided, the kit including instructions for effecting a method of the invention, and program instructions for using the first and second interference data to identify or remove speckle noise.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of an embodiment of the invention showing motion of the sample in a direction of the interrogation beam;

FIG. 2 is a schematic illustration of a waist of a focused beam for which a beam wavefront depends on an axial distance of beam focus to a sample;

FIG. 3 is a two-dimensional OCT image of a tooth taken with the tooth-sample in one position along the sample arm of the system;

FIG. 4 is an averaged image of the tooth obtained by summation of eight OCT images of the same tooth volume, each image acquired with the sample in a different position along the axis of the interferometer sample arm; and

FIG. 5 is a graph plotting a single A-scan of a region of the tooth taken with and without beam wavefront diversity, corresponding to a pixel of the images of FIG. 3 and FIG. 4.

### DESCRIPTION OF PREFERRED EMBODIMENTS

A technique is provided for interferometric detection that identifies or reduces coherent speckle noise. The technique involves obtaining at least two interference data sets representative of a same region on a sample with a same beam along a same angle. Both interference data sets are obtained by interfering collected light from the region after illumination of at least a representative part of the area with an interrogation beam of an interferometer. A beam wavefront of the interrogation beam as it meets the sample is changed so that the two interference data sets represent the same area but are subject to different coherent speckle noise from a beam. The beam wavefront may be varied by changing a transverse mode of the beam, a focus of the beam, an intensity distribution of the beam, or a diameter or shape of the beam. The wavefront of the beam where it meets the sample can be varied by changing an axial position of the sample in a direction of the interference beam, if the interference beam is focused (i.e. convergent or divergent).

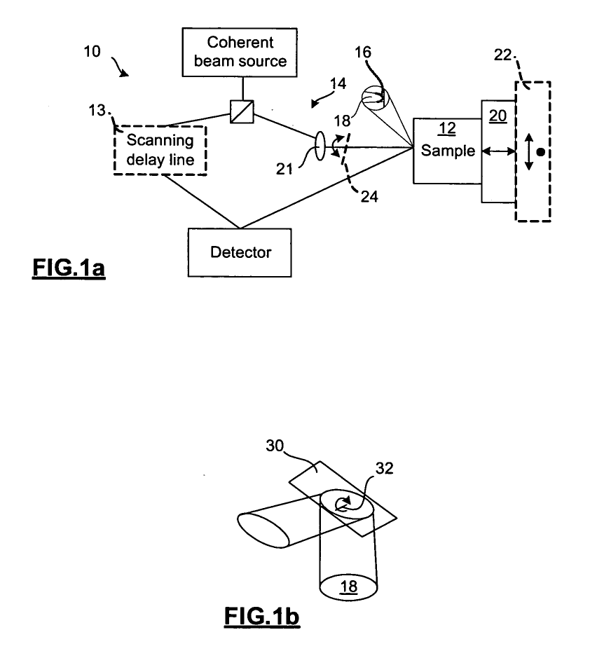

FIG. 1a is a schematic illustration of an apparatus in accordance with an embodiment of the invention. The apparatus comprises an interferometer 10 and a sample 12. The interferometer 10 may be entirely conventional and of substantially any kind. For example, the interferometer 10 may be of the following kinds: Michelson, Fabry-Perot, Fizeau, Sagnac, Fresnel, Fourier-transform, Gires-Tournois, Diffraction-Grating Interface, Linnik, Mach-Zehnder, Mireau, Moire, Newton, Rayleigh, Twyman-Green, Talbot Lau, Watson, and Schlieren.

A reference arm of the interferometer may include an optical delay line 13 for varying an optical path length of a reference beam in a manner known in the art, or may provide a fixed optical path length difference for comparison, in which case the imaging may be of a fixed depth of the sample. The beam may be of any kind, from spectral to very narrow band, of any degree of polarization, and of any coherence length; however interference requires that the light collected from the sample and the reference arm interfere, and accordingly practical constraints on the optical path length difference between the collected light and beam impose a minimum coherence length that depends on the application.

The invention principally involves a sample arm 14 of the interferometer 10 and the sample 12 in that a change of a beam wavefront 16 of an interrogation beam 18 as it meets the sample 12 is changeable by a mechanical actuator 20. In the illustrated example, the interrogation beam 18 is focused (i.e. is converging or diverging) as provided for by a lens 21, for example. Accordingly the interrogation beam 18 has a different beam wavefront 16 at different axial positions along the interrogation beam 18, which may be characterized by respective wavefront diameters. This is why changing the position of the sample in a direction of the beam 18 provides a changed beam wavefront 16 at the sample.

The mechanical actuator may alternatively be mounted to produce an equivalent axial motion of the sample relative to the beam 18. For example, the beam may be delivered to the sample through an optical fiber which may be axially moved by the mechanical actuator in other embodiments.

It will further be appreciated by those of skill in the art that micro-opto-electro-mechanical systems (MOEMS) or other devices in the sample arm of the interferometer 10 could alternatively be used to vary an effective distance between focusing optics of the sample arm and the sample in a manner known in the art. For example, the lens 21 or another element of the sample arm 14 may be moved, tilted or rotated. In embodiments where scanning is performed, it may be accomplished by controlling motion transverse to the beam 18 on a stage, in a manner known in the art, or by scanning the beam 18, with a beam scanning apparatus schematically illustrated as a pivoting element 24.

It will be evident to those skilled in the art that there are many ways of varying a wavefront of a beam while keeping the wavelength/spectrum, coherence length, and polarization constant. In many examples the power of the beam is also kept constant so that there is uniform signal strength at the optical receiver for a given interference value, as is generally desirable, but can be corrected for or compensated for if not provided.

The beam wavefront may be changed (either continuously or discretely) by a mechanical actuator located within the sample arm 14. The actuator may be part of a moving part such as pivoting element 24 that is already used for effecting a scanning of the beam across a surface of the sample. For example, if a beam is reflected by a mirror with reflection properties that are changed by varying a shape of its surface (e.g. by deforming the mirror, or by varying a part of the mirror surface the beam is exposed to, by mechanical or piezoelectric actuation), the actuable mirror may be induced to change the form of the beam wavefront 16. Such change can equally be provided by refraction.

As shown in FIG. 1b, the beam wavefront may be changed from a circular wavefront to an elliptical wavefront, or may scan through a plurality of elliptical wavefronts so that there is no considerable change in diameter of the beam incident the surface, and no power change. A mirror 30 in the sample arm 14 of the interferometer 10 rotating the about an axis 32 other than the mirror normal an elliptical cross-section may be varied cyclically. Compensation for the change in angle of the beam may be provided by motion of the sample, or by optical components. Such change can equally be provided by refraction.

Furthermore known optical path switching technology can be used to send the interrogation beam 18 down different paths, and accordingly the interrogation beam may be subjected to different lenses or other optical devices to shape the wavefront 16 in dependence on the switched state of the sample arm 14.

The amount of change induced in the beam wavefront produced at the location of the scattering object has to be comparable to the size and distribution of scattering features within the sample, in order for the corresponding scattering pattern to be noticeably diverse from one image to another. The degree of change of the wavefront required will therefore depend largely on the sample and the scattering elements therein, the diameter of the beam, and the wavelength or spectrum of the illumination source.

Images at the same sample spot taken along a same axis with the same beam but having different wavefronts at intersection with the sample provide substantially the same backscattering experiment but induce different speckle noise patterns. For this reason, a significant disparity between the two images at a point (and depth if depth scanning is used) indicates a speckle noise artifact, which can be eliminated by averaging, or by inspection of these differences and assigning a local mean, or discounting the spike in the production of a higher quality image.

If the interrogation beam 18 is focused, moving the sample in the direction of the beam will expose the sample to a different wavefront 16. This is a preferred embodiment of the invention as it can be accomplished with only the addition of a small displacement actuator able to displace the sample holder by mechanical, electrical or manual means along the sample arm of a known interferometer.

It will be appreciated that more than two different beam wavefronts 16 can be used to provide respective images for higher quality detection in analogous manner, and further that a continuous cyclic variation can be used where only incremental changes in the beam wavefronts 16 serve for comparison.

Accordingly a single interference value set (e.g. a single interference value or an A-scan) of a sample at a region may be performed first with a first wavefront, and a second interference value set can be produced with the interrogation beam having a second wavefront upon intersection with the sample. A comparison of the corresponding interference values of the first and second sets yields information useful for identifying or reducing coherent speckle noise.

In imaging embodiments, the interrogation beam is scanned across the sample to effectively produce interference value sets for regions that correspond with pixels of the image. The pixels correspond to a two dimensional map of a surface of the sample. If the interference value set is an A-scan, voxel images can be produced with an axis of the image corresponding to a depth of the scan within the sample. A resolution of the pixels is determined by the scan rate and dimensions of the regions, whereas properties of the scanning arm and detector determine the resolution in the depth axis. There are two ways of producing these images commonly used in the art, by continuous scanning or by intermittent scanning.

The intermittent scanning technique is performed by moving the beam to a desired location corresponding to a pixel and then obtaining the interference value set for the location by interfering light collected after the beam interacts with the sample with a reference beam, before moving the beam to a next desired location. Usually the series of points are taken in a sequence referred to as a raster, and the data graphically presented in a corresponding order of the raster is an image.

The interfering of the light may involve multiple comparisons of the collected light with reference arms with different optical path lengths to produce a plurality of interference values at each pixel, as is the case for OCT imaging. Typically the interfering involves superimposing the collected light onto a reference beam that has a path length that varies in time so that at different instants the collected light from a same area is compared with the reference beam of different path length offsets. Each path length offset corresponds to a different depth of the beam within the sample, in the sense that all singly reflected light that constructively interferes with the reference beam at that path length offset was reflected from a same depth in the sample.

A preferred method of implementing this scheme is to provide the reference beam that has a path length that varies in time (linearly or according to a predefined scanning rate) and sampling the interference result at a detector at a given rate that is n times faster than the scanning rate of the reference beam, to produce n values of depth resolution. Each value represents a mean depth corresponding to a mean of the path length differences scanned by the reference beam in the interval.

Using intermittent scanning, first and second scans of the area may be performed with two or more different beam wavefronts before moving the beam to a next area (if there is one).

An advantage of this method is that a comparison of the 1 or n interference values can be performed immediately and used to determine whether there is any speckle (i.e. significant divergence in one or more of the interference values). This means that only a single mean value need be stored for the image and no correlation of pixels is required. Furthermore if a significant divergence is obtained, it is possible to take more interference values with different beam wavefronts to produce a higher accuracy image at only the spots where speckle is detected. Further still noise artifacts caused by continuous scanning may reduce a quality of images when continuous scanning is performed. In spite of these advantages, a time taken to accelerate and decelerate a scanning platform, mechanical demands on the scanning platform, costs of the scanning platform, and accuracy of positioning of the beam make this embodiment less preferred than continuously scanned imaging in some situations.

In either the continuous or intermittent scanning techniques, the beam wavefront may be continuously changed during the illumination and interference, which can be ongoing processes, or the beam wavefront can be changed once and two scans can be made.

In accordance with the intermittent scanning technique, the interrogation beam moves over the surface at a slow enough rate so that there is substantial overlap of the region of illumination throughout the scanning of the reference arm so that the collected light is taken to remain substantially constant for interference with the phase changing reference beam, as throughout the scanning, the collected light is taken to be a constant signal representative of the region.

If the beam traversal rate is sufficiently slow, two or more interference (sets on values may be taken sequentially with different beam wavefronts, provided that switching of the beam wavefronts can be timed to correspond with the reference arm scan. It is generally important that the beam wavefront remain substantially constant throughout the scanning of the reference arm to obtain the interference values without additional noise artifacts.

For expeditious application Applicant prefers to produce the interference values for all areas of interest on the sample, such as through a raster scan to provide the interference values for corresponding pixels of an image, and repeat this process for multiple different beam wavefronts, rather than to alternate the beam wavefront between acquisitions of interference values. The principal advantage of this is that an optimized, existing OCT imaging apparatus can be used without requiring any change in operation that may have an impact on quality of the image, the rate of the image taking, etc. This configuration may require post acquisition realignment of the pixels for comparison, for example, if the sample is moved with respect to the stage while changing the wavefront, or if the registration of the scanning equipment does not ensure that the beam illuminates the same regions during the successive scans. Pixel or sub-pixel alignment can be relatively easily done using known software algorithms, or manually by aligning reference markers, inherent reference points, or by otherwise computing a respective offset of the images. Advantageously once the pixels are aligned, the interference values can be directly compared as the beams used to interrogate the sample are of a same frequency/spectrum, intensity, polarization, and coherence length and accordingly their transmission through the sample is presumed to be substantially the same, unless a phase of the beam is changed with the change of the wavefront, in which case accounting for an offset in the depth direction may also be desired.

It should be noted that in some embodiments of the invention the optical path length difference between the reference arm, and the path of the interrogation beam and collected light is changed to produce the change in beam wavefront. Accordingly compensation for a phase offset between the interference values obtained by the different scans, which represents a change in depth of the scan, may be required so that interference values of corresponding depths are compared. Such compensation may be provided by using a reference marker applied to a surface of the sample, using an inherent marker within the sample as a reference point, and/or using a measure of the displacement of the sample in the direction of the interrogation beam to compute a correction. Naturally averages of the correction factor over a plurality of regions on the sample, may be used to provide a constant correction factor, or correction factors for each image may be provided.

### EXAMPLE

A sample in the form of an extracted wisdom tooth that was preserved in saline water to avoid desiccation was used as an example of a dense biological sample in order to test the method of compounding images for speckle noise reduction in OCT images. The probed region contains a carious lesion that affects both the outer layer of the tooth (the enamel) as well as the underlying tissue (the dentine). As observed during the visual inspection, the lesion manifests itself as a discolored spot on the proximal surface close to the top of the tooth.

The sample was imaged using a standard OCT apparatus consisting of a Michelson interferometer. The electromagnetic source was a super-luminescent SLD-571-HP diode with a center wavelength at 1.31 μm and a measured coherence length of 29 μm (full-width at half-maximum). The electromagnetic source provided a constant beam. A conventional beam splitter was used to divide this beam into reference and sample arms. The beam produced a laser spot size of about 24 microns in diameter.

The carie is presumed to contain voids within a tooth matrix and other scattering objects on the order of 0.5-10 microns, which result in multiply scattered coherent noise that is desirably removed from the image. While there are several ways a wavefront can be made to change, a radius of the wavefront is changed by 25-30% in successive wavefronts used in the present invention. Furthermore the change in radius is provided by a displacement of the sample in a direction of the beam that is greater than a coherence length of the source.

In both arms of the interferometer, sample and reference, light is guided through single-mode fibers. Collimating lenses at the ends of the single-mode fibers in the sample and reference arms served to maintain coherence of the reference and sample beams. In the reference arm a rapid scanning optical delay line with a constant velocity of 655 mm/s with a scanning depth of 4 mm is used to provide a reference arm with a continuously changing phase with respect to the interrogation beam of the sample arm of the interferometer.

A 48-mm focal distance lens with a diameter of 14.5 mm, a measured numerical aperture of 0.095 and a confocal parameter of 1.6 mm calculated at 1.31 μm is located near the exit of the sample fiber for illuminating the sample for the purpose of focusing the collimated light on the tooth, and for collecting the light after interaction with the sample. The fiber-lens assembly is mounted on a computer-controlled horizontal translation stage that scanned the focused spot of the illuminating beam along the tooth surface with a maximum spatial resolution of 1 μm. The tooth was mounted on the stage.

Light collected after interaction with the sample was superimposed on the scanning reference arm to produce an interferogram. The interferogram was sampled at 400 Hz and a 16-bit A/D converter digitized the interference signals.

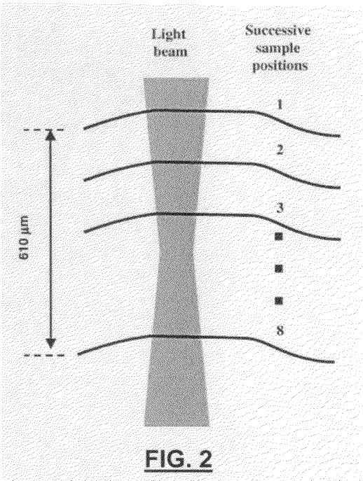

Subsequent images were taken of the tooth with a change in a diameter of the wavefront of the beam as shown in FIG. 2. A mechanical actuator was used to manually change the position of the sample in the direction of the beam. In this example 8 OCT images of the same tooth region were acquired, each image taken at a different position within a spatial range centered about the focal waist of the beam. Specifically the images were taken with distances varied along a 610-μm spatial interval centered around the beam waist. The average displacement of the sample surface between adjacent positions is about 85 μm.

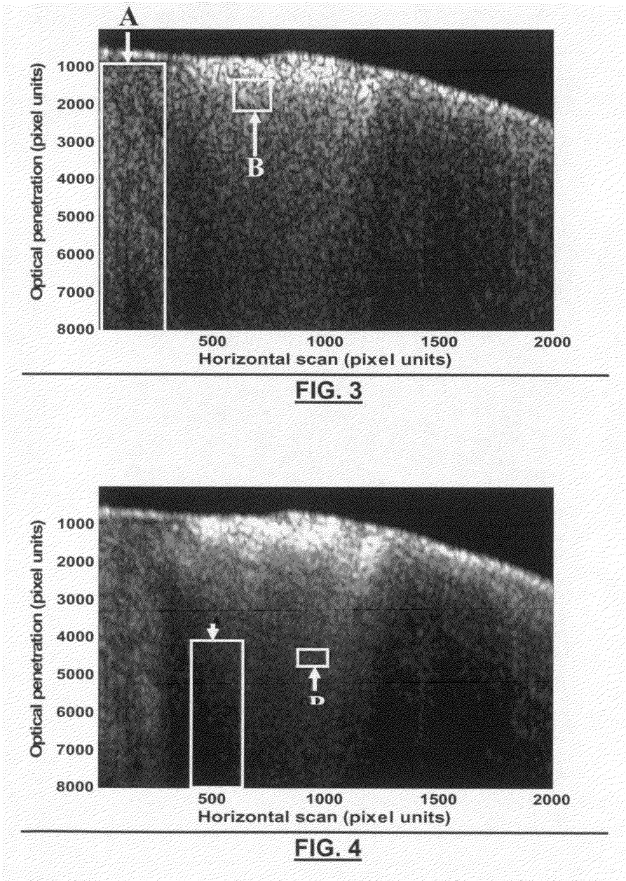

FIG. 3 is a plotted interferogram demodulation image of the tooth including the carious region and healthy regions. The image is a B-scan showing a depth axis in the y direction, and a single line of an image in an x direction. The light penetrates the tissue in the vertical direction. As is known in the art the B-scan is a sequence of A-scans, in this case the B-scan is 2-mm long and is made of a linear array of pixels corresponding to the A-scan regions defined by continuously moving the beam 2 microns. In order to eliminate the random thermal and electronic noise, each A-scan is the average result of 32 depth-scans. The image dimensions correspond approximately to a 2 mm×1 mm slice of the tooth.

Evidently, high-contrast coherent speckle noise is still present in the image as the result of a coherent optical field being strongly scattered by the enamel and dentin matrix. A clear example of such speckle noise is seen in the area contained inside box A, a region where the tooth is healthy with an intact dentine matrix behind the enamel layer. There is no clear dependence of intensity on depth and this is a strong indication that the observed speckle inside box A is mainly the result of multiple scattering events rather than generated by phase changes accumulated during ballistic light propagation through the underlying tissue [15] (i.e. the coherent backscattering of the beam).

Using the definition from Ref. [18] a quantitative measure of random speckle contrast, i.e. the ratio between the standard deviation of the speckle signal and its mean intensity, is found to be 0.87 for the pattern contained inside box A from FIG. 3. The OCT speckle contrast for that region is 22% greater than 0.71, which is the theoretical value corresponding to randomly distributed speckle generated by unpolarized light [18]. Some of the difference from the theoretical value can be attributed to the existence of a preferential polarization direction for light in our OCT system due to the emission of partially polarized radiation by the diode as well as to the beam-splitters and fiber couplers embedded in the optical setup. Another cause for the polarization imbalance can be traced to the birefringence properties that characterize the upper layers of the tooth [26].

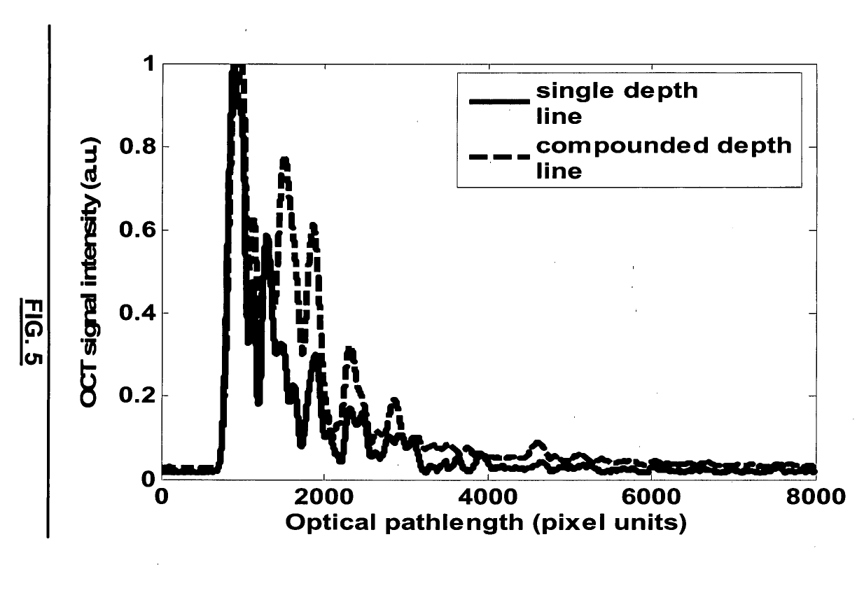

For comparison, FIG. 4 shows an interferogram produced from an average of eight OCT image sets collected at different positions along the sample arm of a focused beam, and thus providing eight fold wavefront diversity. These eight OCT images are acquired within a 610-μm spatial interval centered on the beam waist as shown in FIG. 2. For each new image the tooth surface is displaced about 87 μm along the sample arm from the position where the previous image was acquired.

All eight image sets are collected under the same conditions as the ones used for acquiring the OCT image shown in FIG. 3 and the same probe volume of the sample is selected for each OCT image. Each depth scan of each image of the eight image sets, as before, is an average of 32 scans. Before summation, in order to avoid the blurring of the compounded image, the individual OCT images are shifted for proper alignment using the front of the tooth as a reference. It will be appreciated that by shifting the position of the sample with respect to the beam an offset in the phase of the beam is produced, and as this phase is what is measured by interference, there is a resulting realignment of the spatial information when the position is changed. When the beam is scanned through a depth, for example, the corresponding features of the sample can be used to align the different images. Naturally an algorithm can be used for this alignment such as a regression algorithm when a single feature is not available for clearly identifying and aligning the images. It will be noted that accurate alignment is significantly easier in the present invention as the same beam is used at the same angle resulting in no changes to the geometry or penetration of the beam.

The reduction in speckle noise with respect to the signal-carrying intensity distribution is apparent in the compounded image. FIG. 4 produces a higher quality signal. Due to the physical displacement of the sample, each individual OCT image presents its own speckle generated by multiple scattered photons, speckle that is particular only to that image.

An eight fold increase in a number of scans without wavefront diversity is not expected to have any significant impact on the quality of the images because 32 scans are substantially sufficient for reducing noises attributed to factors other than coherent speckle noise.

The signal generated by single-backreflected coherent photons does not change its distribution under diverse wavefront imaging. As a consequence of the superposition of the images obtained for different positions of the sample in the direction of the interrogation beam, the signal intensity corresponding to the coherently single-backreflected components of the intensity pattern is found to increase in the compounded image when compared to the coherent speckle noise generated by multiply-scattered photons.

For example, due to the spatial image compounding, structures similar to ones inside box B from FIG. 4 can be recognized as real scattering objects unlike in the structures from FIG. 3, where they either cannot be observed because of the surrounding speckle noise or may be regarded as intensity spikes generated by noise of the scattered optical field.

Comparing the speckle noise contrast within box A between FIGS. 3 and 4, we find the speckle noise contrast is 2.65 times lower in FIG. 4. The speckle patterns generated by multi-scattered photons in individual OCT images are uncorrelated [18] and [24]. It is known that the summation of M uncorrelated speckle intensity patterns generated by random scattering results into an image with a fully developed speckle whose contrast is reduced M^{1/2} times [24]. In this case M=8, the loss in contrast for speckle noise in the compounded image is close to (within 7% of) the expected contrast reduction of 2.83. This substantiates the assumption that when displacing the sample by distances greater than the coherence length of the source along a changing optical beam wavefront, the speckle patterns generated by multiple scattering of the optical field are uncorrelated. All necessary requirements for the reduction of speckle noise in the compounded image are fulfilled.

It is noted that the wavefront diverse compounded image of FIG. 4 appears less grainy than the image shown in FIG. 3. By compounding the image with wavefront diverse images, a more accurate estimation of the caries boundaries and of the tooth structure is obtained, with the enamel—dentine interface better delineated. This is best observed in the region unaffected by dental decay that presents a thicker enamel layer located on the right side of the caries.

The ability of this method to improve the quality of the image is apparent when comparing the depth-line wavefronts of the carious lesion obtained in the FIGS. 3 and 4. FIG. 5 is a graphical representation of interference at a single point on the surface comparing results from the images of FIGS. 3 and 4. The abscissa represents the A-scan penetration inside the tooth. The continuous curve shows the intensity beam wavefront along the 675th pixel column from the OCT image in FIG. 3 while the other dashed curve is the corresponding pixel column from the wavefront diverse compounded image shown in FIG. 4. The selected line crosses a tooth section with a very disordered structure due to damage inflicted by the carious lesion. In order to have the same intensity scale for both curves in FIG. 5, the number of OCT images, (i.e. eight), divides the intensity of the compounded depth line.

The large peaks centered on the 1000th pixel in both curves are from the ballistic light reflected on the front tooth surface. In both curves, there is a succession of six major reflective peaks lining up behind the reflection from the tooth surface, located roughly from the 1000th pixel up to the 4000th pixel.

The maxima of these peaks increase in the wavefront diverse compounded case providing evidence, together with their similar locations along both curves, that their intensity is substantially a result of single backscattering events within the damaged tooth matrix. This enhancement is to be expected because while the compounding process increases the intensity of uncorrelated speckle by only M^{1/2}, at the same time, it increases the signal from correlated ballistic photons by M times ([24] and [25]).

Also the method is found to improve the image contrast of the reflecting structures within the tooth without a substantial degradation in resolution because the peaks appear to be equally sharp through both the compounded and OCT images. The evidence shows that the speckle noise generated by multiple-scattered photons is significantly reduced as seen from the elimination in the wavefront diverse compounded beam curve of some of the smaller secondary spikes initially existing along the coherent depth beam wavefront.

Compared to another spatial compounding procedure, angular compounding, our method has the advantage that the optical field propagates through the same sample volume in a same direction for each individual image thus making it more suited to study samples with a high degree of local inhomogeneity.

Advantageously, this method uses a standard OCT system with a full-sized area detector to reduce speckle, avoiding the loss in optical contrast due to the decrease in the numerical aperture of each individual detector that form a detector array [19], as well as the higher cost of the array of detectors.

We foresee several variations that could further reduce coherent speckle noise in OCT images obtained by spatial compounding that use multiple speckle noise reduction techniques concurrently. For example, acquiring a pair of images for each sample position using orthogonal polarizations. In this way an additional decrease of 2^{1/2} times could be achieved for the speckle noise contrast [18] and [24]. A drawback of this approach is that it cannot be used for samples with intrinsic birefringence properties. It also requires an OCT system with similar propagation properties for two orthogonal polarization modes. Another method to diversify the speckle pattern at each position of the sample is to acquire images from OCT sources of different wavelengths. Caution should be exercised when using the multi-wavelength approach in order to avoid image distortion due to optical dispersion.

Spatial compounding of OCT images could be used in conjunction with various theoretical de-noising algorithms such as wavelet filtering, phase domain processing, median filtering or anisotropic diffusion filtering to further reduce coherent speckle noise.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

References: The contents of the entirety of each of which are incorporated by this reference.

[1] D. Huang, E. A. Swanson, C. P. Lin, J. S. Schuman, W. G. Stinson, W. Chang, M. R. Hee, T. Flotte, K. Gregory, C. Puliafito and J. G. Fujimoto, Science 254 (1991), p. 1178.

[2]

J. G. Fujimoto, C. Pitris, S. A. Boppart and M. E. Brezinski, Neoplasia 2 (2000), P. 9.

[3] V. L. Kuz'min and V. P. Romanov, Usp Fiz Nauk 39 (1996), p. 231.

[4] J. G. Fujimoto and M. E. Brezinski, Optical Coherence Tomography Imaging. In: Tuan Vo-Dinh, Editor, Biomedical Photonics Handbook, CRC Press, Washington D.C. (2003).

[5] H. H. Gilgen, R. P. Novak, R. P. Salathe, W. Hodel and P. Beaud, J. Light. Technol. 7 (1989), p. 1225.

[6] T. Fukano and I. Yamaguchi, Opt Lett. 21 (1996), p. 1942.

[7] H. Maruyama, S. Inoue, T. Mitsuyama, M. Ohmi and M. Haruna, Appl. Opt. 41 (2002), p. 1315.

[8] J. Jasapara and S. Wielandy, Opt. Lett. 30 (2005), p. 1018.

[9] E. A. Swanson, J. A. Izatt, M. R. Hee, D. Huang, C. P. Lin, J. S. Schuman, C. A. Puliafito and J. G. Fujimoto, Opt. Lett. 18 (1993), p. 1864.

[10] J. A. Izatt, M. R. Hee, E. A. Swanson, C. P. Lin, D. Huang, J. S. Schuman, C. A. Puliafito and J. G. Fujimoto, Arch. Ophthalmology 112 (1994), p. 1584.

[11] F. I. Feldchtein, G. V. Gelikonov, V. M. Iksanov, R. R. Kuranov, A. M. Sergeev, N. D. Gladkova, M. N. Ourutina, J. A. Warren and D. H. Reitze, Opt. Express 3 (1998), p. 239.

[12] J. M. Schmitt, A. Knüttel, M. Yadlovski and M. A. Eckhaus, Phys. Med. Biol. 39 (1994), p. 1705.

[13] J. G. Fujimoto, S. A. Boppart, G. J. Tearney, B. E. Bouma, C. Pitris and M. E. Brezinski, Heart 82 (1999), p. 128.

[14] J. A. Izatt, M. D. Kulkarni, W. Hsing-Wen, K. Kobayashi and M. V. Sivak Jr., IEEE J. Sel. Top. Quantum Electron. 2 (1996), p. 1017.

[15] J. M. Schmitt, S. H. Xiang and K. M. Yung, J. Biomed. Opt. 4 (1999), p. 95.

[16] B. Karamata, M. Laubscher, M. Leutenegger, S. Bourquin, T. Lasser and P. Lambelet, J. Opt. Soc. Am. A. 22 (2005), p. 1369.

[17] T. S. McKechnie In: J. C. Dainty, Editor, Laser Speckle and Related Phenomena, Springer, Berlin (1984).

[18] J. W. Goodman In: J. C. Dainty, Editor, Laser Speckle and Related Phenomena, Springer, Berlin (1984).

[19] J. M. Schmitt, Phys. Med. Biol. 42 (1997), p. 1427.

[20] M. Bashkansky and J. Reintjes, Opt. Lett. 25 (2000), p. 545.

[21] M. Kobayashi, H. Hanafusa, K. Takada and J. Noda, J. Lightwave Technol. 9 (1991), p. 623.

[22] M. Pircher, E. Gotzinger, R. Leitgeb, A. F. Fercher and C. K. Hitzenberger, J. Biomed. Opt. 8 (2003), p. 565.

[23] K. M. Yung, S. L. Lee and J. M. Schmitt, J. Biomed. Opt. 4 (1999), p. 125.

[24] J. W. Goodman, J. Opt. Soc. Am. 66 (1976), p. 1145.

[25] P. M. Shankar and V. L. Newhouse, IEEE Trans. Son. Ultrason. 32 (1985), p. 537.

[26] D. Fried, J. Xie, S. Shafi, J. D. B. Featherstone, T. M. Breunig, C. Le, Proceedings of SPIE, vol. 4610, 2002, p. 113.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A method for interference detection, the method comprising:
producing two sets of interference values respectively from first and second instances of a beam after interaction with a sample at a region of the sample, the first and second instances of the beam both taken to be representative of the sample at the region, wherein the first and second instances of the beam have a same nominal wavelength, intensity, polarization and coherence length, and meet the sample at substantially a same angle, but have different beam wavefronts upon intersection with the sample; and
using differences between the two sets of interference data to identify or reduce speckle noise.

2. The method of claim 1 wherein a number of different beam wavefronts greater than two are used to produce a corresponding number of sets of interference values.

3. The method of claim 1 wherein producing the two sets of interference data comprises producing two sets of interference data for the region in sequence with a number of like regions distributed substantially uniformly over a surface of the sample, the two sets of interference data for each region providing an image of the sample with each pixel of the image corresponding to one region of the sample.

4. The method of claim 3 wherein producing the two sets of interference data comprises:
imaging the sample with the first instance of the beam at the number of like regions;
changing the beam wavefront to that of the second instance of the beam; and
imaging of the sample with the second instance of the beam at the number of like regions; and
wherein using the differences comprises aligning the pixels of the produced images to compare pixels of data produced from substantially overlapping regions.

5. The method of claim 3 wherein producing the two sets of interference data comprises acquiring a first of the two sets of interference data from the first instance of the beam, and acquiring a second of the two sets of interference data at the region prior to repositioning the beam to a next of the like regions.

6. The method of claim 5 wherein repositioning the beam comprises moving the beam and stopping it at the next of the like regions.

7. The method of claim 5 wherein repositioning the beam comprises continuously moving the beam over the sample at a slow enough speed that both instances of the beam after interaction represent the same region.

8. The method of claim 1 wherein producing each of the two sets of interference data comprises producing an A-scan for the region having a plurality interference values corresponding to respective depths within the sample, wherein using the difference between the first and second interference data involves comparing the interference values of corresponding depths of the first and second interference value sets.

9. The method of claim 8 wherein producing the A-scan comprises:
superposing the beam instance after interaction on a optical path length scanned reference beam that changes an optical path length cyclically within a depth scan period, and
sampling an interference signal produced by the superposition at a rate n times higher than the depth scan period to produce n interference values.

10. An interferometric detection method comprising:
illuminating a spot on a sample within a region of the sample with a beam of light having an axis, the beam having a first wavefront where it intersects the sample, and having a constant nominal wavelength, intensity, polarization and coherence length;
producing first interference data of the sample from light collected after interaction with the sample which is taken to be representative of the region;
illuminating a second spot on the sample within the region with the beam along the axis, the beam having a second beam wavefront where it intersects the sample;
producing second interference data from light collected after interaction of the second spot with the sample which is also taken to be representative of the region; and
using a difference between the first and second interference data to identify or reduce speckle noise.

11. The method of claim 10 wherein:
illuminating the spot is performed by scanning the beam across a surface of the sample;
producing the first interference data comprises acquiring interference values of the collected light from the region in sequence with acquisition of interference values of collected light from a plurality of sequentially illuminated, neighbouring regions to produce a first image of the sample;
changing the beam wavefront of the beam and reapplying the steps of illuminating and producing to obtain a second image of the sample; and
using the difference between the first and second interference data involves spatially aligning pixels of the first and second images.

12. The method of claim 10 wherein
acquiring the interference values of the collected light from the pixel area comprises independently interfering the collected light received from a respective region with a coherent reference having a plurality of optical path length offsets to produce a plurality of interference values for each pixel, each interference value for a given pixel corresponding to an intensity of light reflected from a respective depth of the sample, and
using the difference between the first and second interference data involves comparing the interference values of corresponding depths of corresponding pixels of the first and second interference images.

13. The method of claim 10 wherein scanning the beam across the sample comprises continuous motion of the beam during the illuminating and producing.

14. The method of claim 10 further comprising scanning the beam across the pixel area while gradually changing from the first to second beam wavefront.

15. An interferometric imaging method comprising:
illuminating a spot within a region on a sample with a focused beam of light along an axis at a first axial distance;
collecting light after interaction with the sample to produce first interference data taken to be representative of the region;
illuminating a second spot within the region on the sample with the focused beam along the axis at a second axial distance different from the first axial distance;
collecting light after interaction with the sample to produce second interference data also taken to be representative of the region; and
using a difference between the first and second interference images to identify or reduce speckle noise.

16. The method of claim 15 wherein collecting light to produce the first and second interference data comprises independently interfering the collected light received from the region with a coherent reference having a plurality of optical path length offsets to produce a plurality of interference values for each pixel, each interference value for a given region corresponding to an intensity of light reflected from a respective depth of the sample, and wherein using the difference between the first and second interference data involves comparing the interference values of corresponding depths.

17. The method of claim 15 wherein scanning the beam across the sample comprises continuous motion of the beam during the illuminating and collecting.

18. The method of claim 15 further comprising scanning the beam across the pixel area while gradually changing from the first to second beam wavefront.

19. An interferometric imaging system comprising:
an optical path between a light source and a sample, for directing a focused beam onto a pixel area on the sample along an axis;
a mechanical actuator for changing an axial distance of the beam to the pixel area; and
backscattered beams of light collected from the sample at two different axial distances but at substantially the same angle for interference with respective reference beams.
